(19) United States
(12) Patent Application Publication
(10) Pub. No.: US 2024/0334380 A1
(43) Pub. Date: Oct. 3, 2024

(54) Detecting Vehicle Tracking Device Anomalies

(71) Applicant: International Business Machines Corporation, Armonk, NY (US)

(72) Inventors: Gabriele Ranco, Udine (IT); Corneliu Nicolae Barbulescu, Otopeni (RO); Erik Rueger, Ockenheim (DE); Utz Bacher, Dettenhausen (DE)

(21) Appl. No.: 18/190,375

(22) Filed: Mar. 27, 2023

(51) Int. Cl. H04W 64/00; G01C 21/34

(52) U.S. Cl. CPC H04W 64/003; G01C 21/34

(57) ABSTRACT

Detecting vehicle tracking device anomaly is provided. Data signals are collected via a network from a tracking device installed in a vehicle to form collected data signals. An anomaly is detected in the tracking device by applying a classification algorithm to the collected data signals.

### BACKGROUND

The disclosure relates generally to vehicle tracking devices and more specifically to detecting vehicle tracking device anomalies based on data signals generated by the tracking devices, themselves, using grouping and classification algorithms.

A vehicle tracking device is an electronic device that records information corresponding to the vehicle as it moves. For example, the tracking device can record information such as driving patterns, geolocation, speed, when and where the vehicle starts and stops, and the like. Most tracking devices are compact and can be installed in an interior compartment of the vehicle (e.g., glove compartment, console, dashboard, or the like) or may be installed in an exterior compartment (e.g., trunk compartment, engine compartment, or the like). Many insurance companies offer discounts for installing a tracking device in a vehicle because the tracking device encourages safe driving.

### SUMMARY

According to one illustrative embodiment, a computer-implemented method for detecting vehicle tracking device anomaly is provided. A computer collects data signals via a network from a tracking device installed in a vehicle to form collected data signals. The computer detects an anomaly in the tracking device by applying a classification algorithm to the collected data signals. According to other illustrative embodiments, a computer system and computer program product for detecting vehicle tracking device anomaly are provided.

### BRIEF DESCRIPTION OF THE DRAWINGS

FIG. 1 is a pictorial representation of a computing environment in which illustrative embodiments may be implemented;

FIG. 2 is a diagram illustrating an example of a tracking device anomaly detection system in accordance with an illustrative embodiment;

FIG. 3 is a diagram illustrating an example of an entity reference table in accordance with an illustrative embodiment;

FIGS. 4A-4B are a diagram illustrating an example of a tracking device signals table in accordance with an illustrative embodiment;

FIG. 5 is a diagram illustrating an example of a trip table in accordance with an illustrative embodiment;

FIG. 6 is a diagram illustrating an example of a trip information table in accordance with an illustrative embodiment;

FIG. 7 is a diagram illustrating an example of a trip type clustering data table in accordance with an illustrative embodiment;

FIG. 8 is a diagram illustrating an example of a feature table in accordance with an illustrative embodiment;

FIGS. 9A-9B are a flowchart illustrating a process for detecting vehicle tracking device anomaly in accordance with an illustrative embodiment; and

FIG. 10 is a flowchart illustrating a process for anomaly detection in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

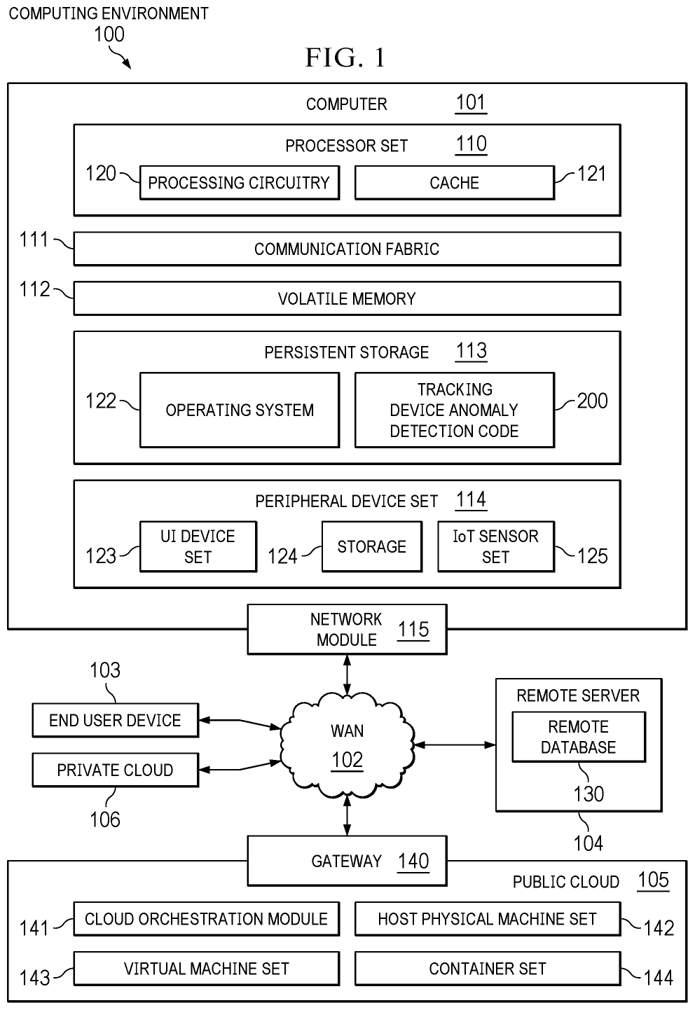

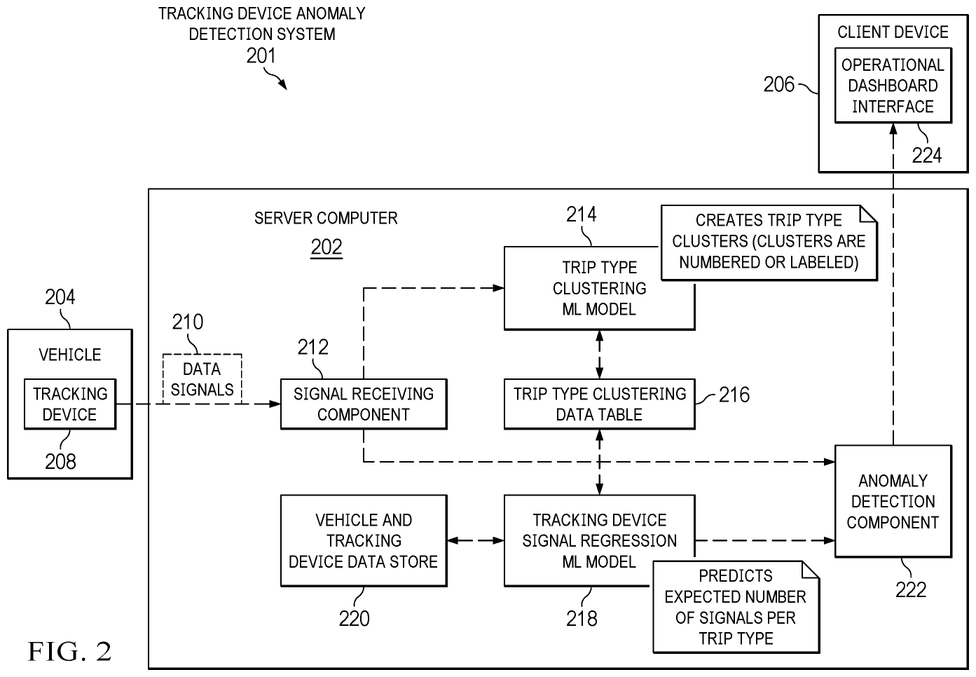

With reference now to the figures, and in particular, with reference to FIGS. 1-2, diagrams of data processing environments are provided in which illustrative embodiments may be implemented. It should be appreciated that FIGS. 1-2 are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of an environment for the execution of at least some of the computer code involved in performing the inventive methods, such as tracking device anomaly detection code 200. For example, tracking device anomaly detection code 200 utilizes data generated by an Internet of Things (IoT) tracking device (e.g., a system of IoT sensors), which is installed in a vehicle, to determine whether the IoT tracking device, itself, is oriented correctly in the vehicle. IoT is a network of devices that collect and share data regarding their operation and/or the environment surrounding them via the Internet. The vehicle can be, for example, a car, truck, van, utility vehicle, bus, tractor-trailer, or the like. The IoT tracking device generates data while the vehicle is operating and moving on a pathway, such as, for example, a street, thoroughfare, urban road, rural road, highway, interstate, or the like.

Tracking device anomaly detection code 200 detects anomalies (e.g., misorientation) of the IoT tracking device in the vehicle, which affects the ability of an entity (e.g., insurance company or the like) to detect whether the vehicle was involved in an accident based on the number of data signals received from the IoT tracking device indicating, for example, vehicle speed, acceleration, direction of movement (e.g., lateral movement), and the like. Vehicles having an IoT tracking device in an incorrect orientation appear to be continually in an accident situation, which creates confusion as to whether a vehicle was actually in an accident or not. Tracking device anomaly detection code 200 detects IoT tracking device anomalies by comparing a predicted number of data signals, which are expected to be generated by an IoT tracking device, for a particular type of trip with an actual number of data signals generated by and received from the IoT tracking device for that particular type of trip.

Tracking device anomaly detection code 200 clusters trips by type utilizing a grouping algorithm, such as, for example, a trip type clustering machine learning model, which is an unsupervised machine learning model. Tracking device anomaly detection code 200 utilizes a classification algorithm, such as, for example, a tracking device signal regression machine learning model, which is a supervised machine learning model, to predict the expected number of data signals generated by an IoT tracking device per trip type.

Tracking device anomaly detection code 200 is able to detect IoT tracking device anomalies (e.g., misorientation) by comparing the actual number of data signals received from an IoT tracking device with the predicted number of data signals for that particular trip type. Thus, tracking device anomaly detection code 200 utilizes a combination of grouping and classification algorithms to identify when IoT tracking devices are installed incorrectly (i.e., misoriented) in vehicles based on actual data received from the IoT tracking devices, themselves.

In addition to tracking device anomaly detection code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and tracking device anomaly detection code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, mainframe computer, quantum computer, or any other form of computer now known or to be developed in the future that is capable of, for example, running a program, accessing a network, and querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in Tracking device anomaly detection code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The tracking device anomaly detection code included in block 200 includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as goggles and smart watches), keyboard, mouse, printer, touchpad, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

EUD 103 is any computer system that is used and controlled by an end user (for example, a user of the tracking device anomaly detection service provided by computer 101), and may take any of the forms discussed above in connection with computer 101. EUD 103 typically receives helpful and useful data from the operations of computer 101. For example, in a hypothetical case where computer 101 is designed to provide a tracking device anomaly notification to the end user, this tracking device anomaly notification would typically be communicated from network module 115 of computer 101 through WAN 102 to EUD 103. In this way, EUD 103 can display, or otherwise present, the tracking device anomaly notification to the end user. In some embodiments, EUD 103 may be a client device, such as thin client, heavy client, mainframe computer, desktop computer, laptop computer, handheld computer, smart phone, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a tracking device anomaly prediction based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

At this time, entities, such as insurance companies, to provide better service and prevent deception, are requesting that their customers install IoT tracking devices in their vehicles. Despite the customary accuracy of these IoT tracking devices, an incorrect installation of an IoT tracking device can decrease its performance. In fact, if the IoT tracking device is not oriented properly in accordance with IoT tracking device guidelines or specifications, the IoT tracking device will generate incorrect or erroneous data signals and indications. Sometimes, due to inexperience or unfamiliarity of an IoT tracking device installer, the IoT tracking device is installed incorrectly in the vehicle. Sometimes, due to specific limitations of the vehicle, it is not possible to put the IoT tracking device in the correct orientation. Currently, no method exists for determining proper orientation of IoT tracking devices in vehicles while the vehicles are in operational mode except via manual human observation and analysis.

The number of data signals generated by an IoT tracking device is a signature of correct or incorrect IoT tracking device orientation in a vehicle due to the manner in which these IoT tracking devices normally operate. For example, these IoT tracking devices are comprised of one or more systems of sensors in which each sensor detects a different movement of the vehicle, such as acceleration, speed, direction, rotation, geolocation, lateral movement, and the like. When one or more of these sensors detect a sudden increase in acceleration and movement that is inconsistent with the direction of movement of the vehicle, the IoT tracking device increases the frequency (i.e., number) of generated data signals sent to a tracking device signal receiving component, which processes the received data signals. When an IoT tracking device is incorrectly oriented in a vehicle, the number of data signals generated by the incorrectly oriented IoT tracking device is higher because the incorrectly oriented IoT tracking device is always in accident mode given that the incorrectly oriented IoT tracking device is interpreting normal movement of the vehicle as an aberrant movement in an unexpected direction.

Illustrative embodiments provide a novel solution that is driven by the data signals received from these IoT tracking devices, themselves, to detect anomalies, such as misorientation, of IoT tracking devices in vehicles. This novel solution includes two steps. One step clusters trips completed by vehicles by type of trip, such as, for example, road type, speed, distance and duration (e.g., limited trip, local trip, extended trip, remote trip, regional trip, national trip, or international trip), and the like. The other step predicts the expected number of data signals of a given vehicle for a particular type of trip based on the total number of trips included in a given cluster, which corresponds to that particular type of trip.

Illustrative embodiments utilize a grouping algorithm and a classification algorithm to perform the two steps above to detect misorientation of IoT tracking devices in vehicles. The grouping algorithm can be, for example, a trip type clustering machine learning model, which utilizes unsupervised machine learning, to group trips completed by vehicles into clusters by type of trip. The classification algorithm can be, for example, a tracking device signal regression machine learning model, which utilizes supervised machine learning, to predict the expected number of data signals to be received from an IoT tracking device for a given vehicle for a particular trip type.

In addition, illustrative embodiments utilize an anomaly detection component to determine whether a particular IoT tracking device installed in an operating vehicle is in an anomalous state or not. The anomaly detection component determines whether a particular IoT tracking device within an operating vehicle is in an anomalous state by comparing the actual number of data signals received from that particular IoT tracking device with the expected number of data signals predicted by the tracking device signal regression machine learning model to be received. A deviation that is greater than a predefined maximum deviation threshold level between the actual number of data signals and the expected number of data signals will cause illustrative embodiments to report an anomalous IoT tracking device (e.g., misoriented IoT tracking device in the vehicle) to an operational dashboard interface on a client device so that a user, who is associated with the insurance company that insures the vehicle, can act upon this information (e.g., generate a work ticket to have an authorized technician reposition the IoT tracking device to a correct orientation in the vehicle).

IoT tracking devices transmit data signals on a continuous time interval basis (e.g., every 1 second, 2 seconds, 3 seconds, or any other defined time interval) during vehicle operation. The tracking device signal receiving component collects these IoT tracking device data signals and processes the data signals to determine, for example, vehicle trip start time and end time, vehicle average speed, vehicle acceleration (e.g., minimum, average, and maximum acceleration) in different axes (e.g., x-axis, y-axis, and z-axis), vehicle geolocation (e.g., geographic longitude and latitude), and the like. Illustrative embodiments input this data into the trip type clustering machine learning model. Illustrative embodiments store trip type data generated by the trip type clustering machine learning model in a trip type data table or database. In addition, illustrative embodiments utilize the output of the tracking device signal regression machine learning model as input to the anomaly detection component.

The trip type clustering machine learning model utilizes the information contained in the trip type data table to group trips that are the same as, or similar to, each other into a trip type cluster, which corresponds to a particular type of trip. Further, the tracking device signal regression machine learning model accesses the information in the trip type data table to make its prediction regarding the expected number of data signals for a given vehicle for a particular trip type. Illustrative embodiments store vehicle and IoT tracking device reference data in a vehicle and tracking device data store. Vehicle reference data can include, for example, make, model, weight, dimensions, vehicle identification number, and the like, for each respective registered vehicle equipped with an IoT tracking device. IoT tracking device reference data can include, for example, identifier such as an international mobile equipment identity number of each respective IoT tracking device, model number, device type, standard signal frequency of each particular IoT tracking device per model or type, and the like.

The tracking device signal receiving component records the timestamp of each received IoT tracking device signal, along with the vehicle geolocation corresponding to each received IoT tracking device signal. Further, the tracking device signal receiving component sends trip information, such as, for example, trip identifier, trip duration, trip distance, vehicle average speed during trip, vehicle acceleration, and the like, which corresponds to each completed trip, to the trip type clustering machine learning model to place the trip information in an appropriate trip type cluster in accordance with the type of that particular trip.

The tracking device signal receiving component identifies the end of a particular trip by, for example, receiving a specific end signal from an IoT tracking device when the vehicle is turned off, not receiving a signal from the IoT tracking device for a defined interval of time (e.g., 15 seconds, 30 seconds, 1 minute, 2 minutes, or any other defined time interval), or the like. It should be noted that the IoT tracking device does not generate certain trip information regarding trip duration, trip distance, vehicle average speed during trip, vehicle acceleration in different axes, and the like, but are instead calculated by the tracking device signal receiving component. The tracking device signal receiving component calculates that particular trip information because the IoT tracking device can generate anomalous data regarding, for example, vehicle acceleration when the IoT tracking device is incorrectly oriented in the vehicle. However, the IoT tracking device can send accurate data regarding the starting and ending geolocation of the vehicle even though the IoT tracking device may be incorrectly oriented in the vehicle. Illustrative embodiments store the information contained in the data signals received from the IoT tracking device in a set of tables.

Thus, illustrative embodiments provide one or more technical solutions that overcome a technical problem with detecting vehicle tracking device anomalies while the vehicles are operating. As a result, these one or more technical solutions provide a technical effect and practical application in the field of vehicle tracking devices.

With reference now to FIG. 2, a diagram illustrating an example of a tracking device anomaly detection system is depicted in accordance with an illustrative embodiment. Tracking device anomaly detection system 201 may be implemented in a computing environment, such as computing environment 100 in FIG. 1. Tracking device anomaly detection system 201 is a system of hardware and software components for detecting tacking device anomalies, such as, for example, tracking device misorientation, in vehicles while the vehicles are in operational mode.

In this example, tracking device anomaly detection system 201 includes server computer 202, vehicle 204, and client device 206. Server computer 202 may be, for example, computer 101 in FIG. 1. Vehicle 204 may be any type of motorized vehicle that travels along roadways and has tracking device 208 installed. Client device 206 may be, for example, EUD 103 in FIG. 1. However, it should be noted that tracking device anomaly detection system 201 is intended as an example only and not as a limitation on illustrative embodiments. For example, tracking device anomaly detection system 201 can include any number of server computers, vehicles with tracking devices, client devices, and other devices and components not shown.

In this example, server computer 202 includes signal receiving component 212, trip type clustering machine learning model 214, trip type clustering data table 216, tracking device signal regression machine learning model 218, vehicle and tracking device data store 220, and anomaly detection component 222. Server computer 202 utilizes signal receiving component 212 to receive data signals 210 from tracking device 208. Data signals 210 contain a plurality of different information regarding the operation and movement of vehicle 204 during a trip. The trip starts when a driver turns vehicle 204 on and ends when the driver turns vehicle 204 off. Signal receiving component 212 processes data signals 210 received from tracking device 208 to determine, for example, road type that vehicle 204 is traveling on, average speed of vehicle 204 during the trip, overall distance of the trip made by vehicle 204, time duration of the trip in seconds, minutes, hours, days, or the like, direction of movement of vehicle 204, acceleration of movement in different axes, and the like.

After processing data signals 210 and determining the trip information corresponding to vehicle 204, signal receiving component 212 sends the determined trip information to trip type clustering machine learning model 214. Trip type clustering machine learning model 214 analyzes the trip information corresponding to vehicle 204. Based on the analysis of the trip information, trip type clustering machine learning model 214 places the trip information regarding vehicle 204 in a particular trip type cluster corresponding to the type of trip made by vehicle 204. Further, trip type clustering machine learning model 214 records the trip information regarding vehicle 204 and an identifier of that particular trip type cluster in trip type clustering data table 216.

Tracking device signal regression machine learning model 218 accesses the information contained in trip type clustering data table 216 and the information contained in vehicle and tracking device data store 220 to predict an expected number of data signals 210 that should have been received from tracking device 208 for a given type of the trip corresponding to that particular trip type cluster associated with the trip made by vehicle 204. Tracking device signal regression machine learning model 218 sends the expected number of data signals 210 that should have been received from tracking device 208 for the given type of the trip to anomaly detection component 222. In addition, signal receiving component 212 sends the actual number of data signals 210 that were received from tracking device 208 to anomaly detection component 222.

Anomaly detection component 222 compares the expected number of data signals 210 that should have been received from tracking device 208 for the given type of the trip with the actual number of data signals 210 that were received from tracking device 208 for the trip made by vehicle 204. If anomaly detection component 222 determines that the difference between the expected number of data signals 210 that should have been received from tracking device 208 and the actual number of data signals 210 that were received from tracking device 208 is greater than a defined maximum threshold level, then anomaly detection component 222 determines that an anomaly exists in tracking device 208. The anomaly may be, for example, misorientation of tracking device 208 in vehicle 204. Alternatively, the anomaly may be a software issue (e.g., software error) or a hardware issue (e.g., sensor failure) in tracking device 208. In response to determining that an anomaly exists in tracking device 208, anomaly detection component 222 sends a notification regarding the anomaly to a user of client device 206 via operational dashboard interface 224.

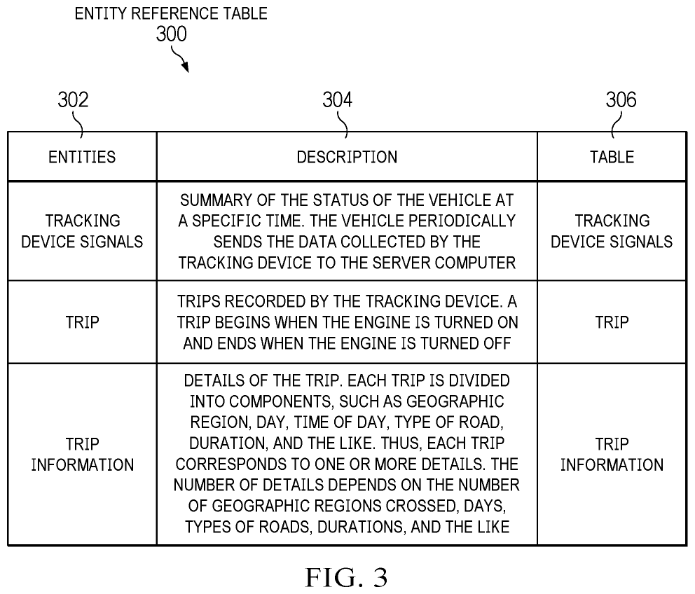

With reference now to FIG. 3, a diagram illustrating an example of an entity reference table is depicted in accordance with an illustrative embodiment. Entity reference table 300 can be implemented by a tracking device signal receiving component of a computer, such as, for example, signal receiving component 212 of server computer 202 in FIG. 2.

In this example, entity reference table 300 includes 3 columns: entities 302, description 304, and table 306. Entities 302 identifies the different entities such as tracking device signals, trip, and trip information. Description 304 provides a brief summary or details regarding each respective entity. Table 306 identifies the particular table that each respective entity corresponds to, such as a tracking device signals table, trip table, and trip information table.

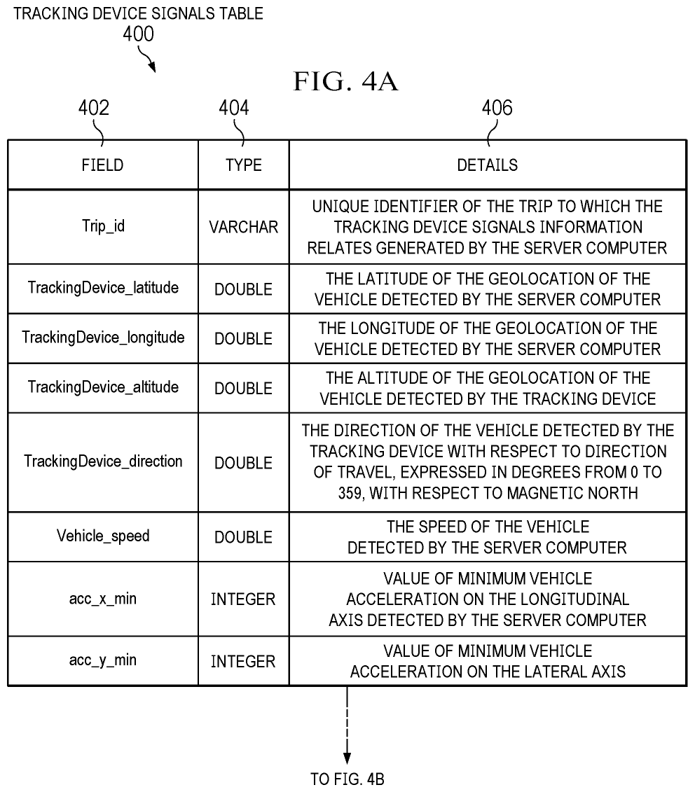

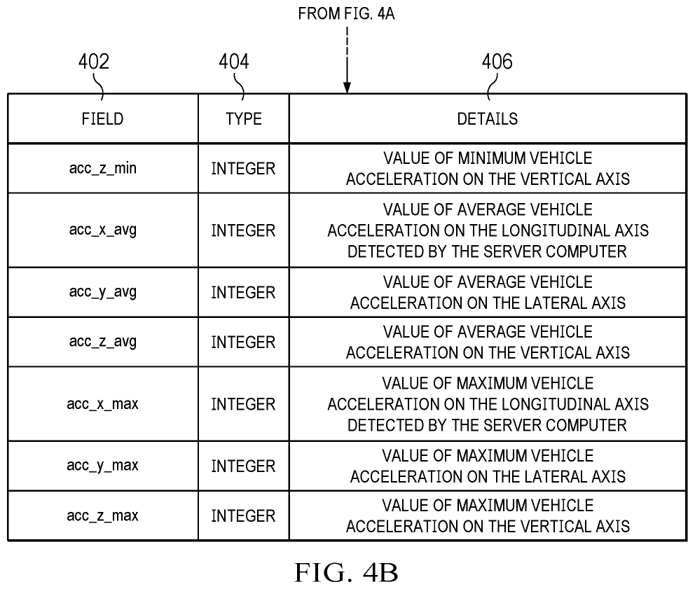

With reference now to FIGS. 4A-4B, a diagram illustrating an example of a tracking device signals table is depicted in accordance with an illustrative embodiment. Tracking device signals table 400 can be implemented in, for example, a tracking device signal receiving component such as signal receiving component 212 in FIG. 2.

In this example, tracking device signals table 400 includes 3 columns: field 402, type 404, and details 406. Field 402 identifies a name of the information contained in each respective field. Type 404 identifies the kind of information contained in each respective field. Details 406 provides a brief description of what information is provided by each respective field.

Tracking device signals table 400 records information corresponding to data signals received from a tracking device installed in a vehicle, such as, for example, data signals 210 received from tracking device 208 that is installed in vehicle 204 in FIG. 2. The recorded data signals represent segments of the trip corresponding to the vehicle. The tracking device signal receiving component counts the total number of data signals actually received from the tracking device. The tracking device signal receiving component only records information from the tracking device such as tracking device altitude, direction, geolocation, and the like, which are not related to tracking device anomaly. The tracking device signal receiving component generates all the information that impacts tracking device anomaly such as vehicle acceleration, speed, and variation in direction of movement in different axes.

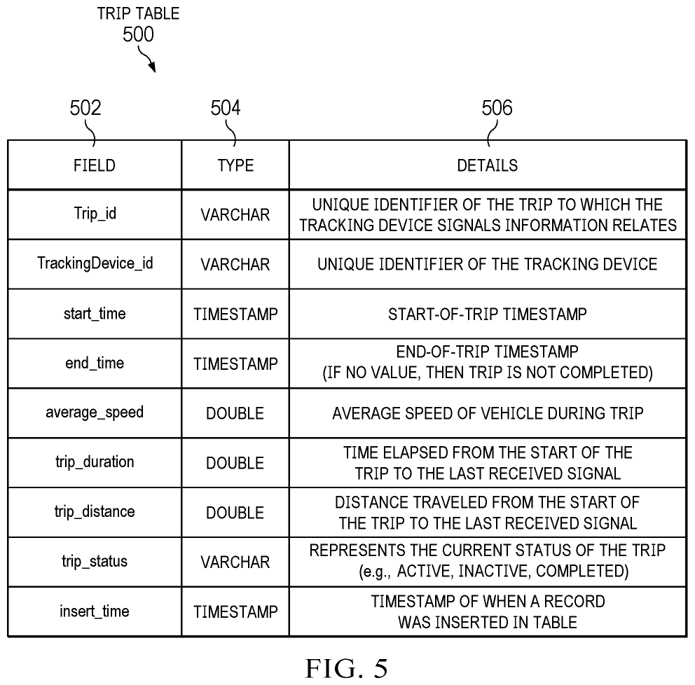

With reference now to FIG. 5, a diagram illustrating an example of a trip table is depicted in accordance with an illustrative embodiment. Trip table 500 can be implemented in, for example, a tracking device signal receiving component such as signal receiving component 212 in FIG. 2.

In this example, trip table 500 includes 3 columns: field 502, type 504, and details 506. Field 502 identifies a name of the information contained in each respective field. Type 504 identifies the kind of information contained in each respective field. Details 506 provides a brief description of what information is provided by each respective field.

Trip table 500 records completed trips made by registered vehicles having a tracking device installed. In other words, trip table 500 contains travel statistics, such as, for example, start time, end time, average vehicle speed, trip duration, trip distance, trip status, and the like.

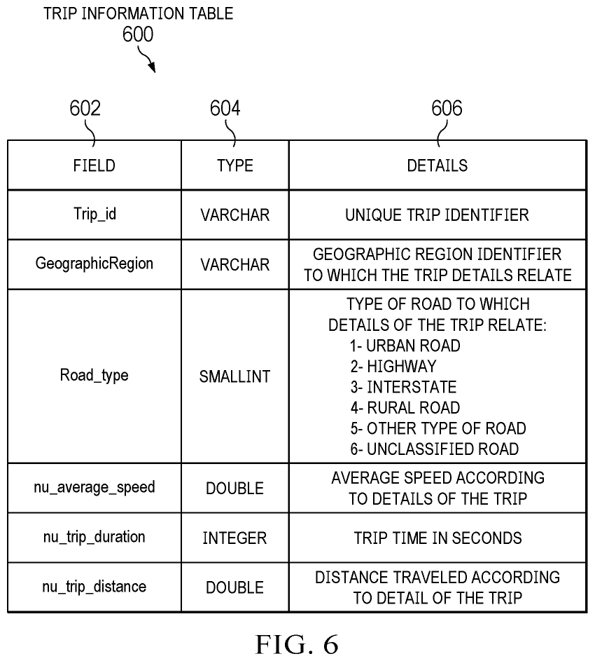

With reference now to FIG. 6, a diagram illustrating an example of a trip information table is depicted in accordance with an illustrative embodiment. Trip information table 600 can be implemented in, for example, a tracking device signal receiving component such as signal receiving component 212 in FIG. 2.

In this example, trip information table 600 includes 3 columns: field 602, type 604, and details 606. Field 602 identifies a name of the information contained in each respective field. Type 604 identifies the kind of information contained in each respective field. Details 606 provides a brief description of what information is provided by each respective field.

Trip information table 600 is a specialization of trip table 500 in FIG. 5. For example, trip information table 600 records additional travel statistics for each trip, such as identification of geographic region traveled, identification of type of road traveled, and the like.

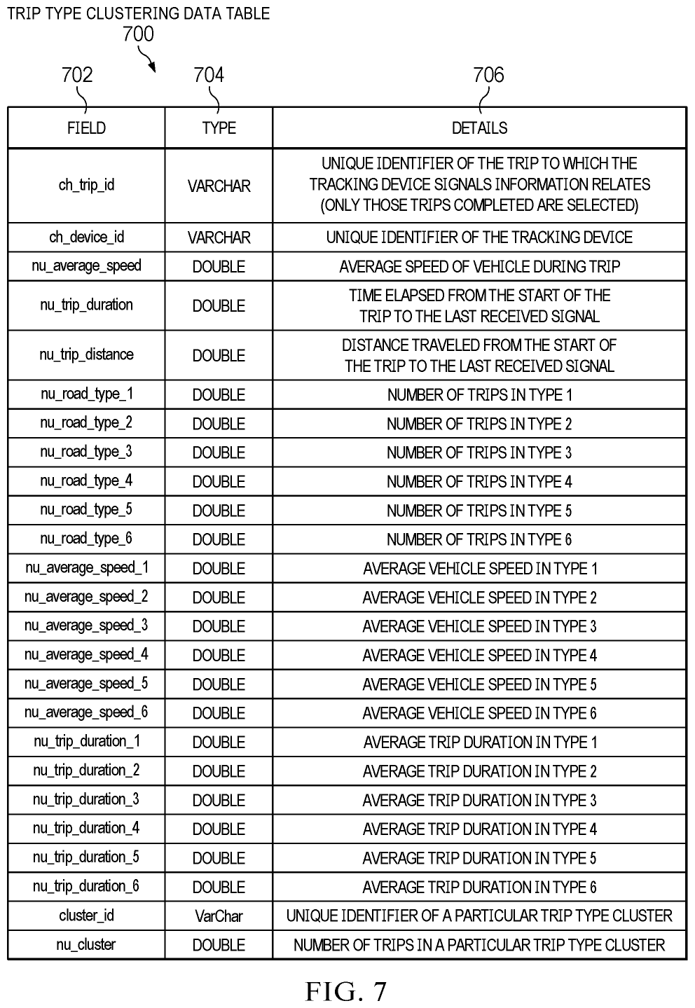

With reference now to FIG. 7, a diagram illustrating an example of a trip type clustering data table is depicted in accordance with an illustrative embodiment. Trip type clustering data table 700 can be implemented by, for example, a trip type clustering machine learning model such as trip type clustering machine learning model 214 in FIG. 2. Trip type clustering data table 700 may be, for example, trip type clustering data table 216 in FIG. 2.

In this example, trip type clustering data table 700 includes 3 columns: field 702, type 704, and details 706. Field 702 identifies a name of the information contained in each respective field. Type 704 identifies the kind of information contained in each respective field. Details 706 provides a brief description of what information is provided by each respective field.

The trip type clustering machine learning model assigns each completed trip to a trip type cluster based on the type of trip made by the vehicle and records, for example, the trip identifier, tracking device identifier, average vehicle speed, trip duration, trip distance, road type, average speed for each road type, trip duration for each road type, cluster identifier, number of trips in a cluster, and the like in trip type clustering data table 700. The total number of possible trip type clusters are defined after training of the trip type clustering machine learning model is completed. It should be noted that the data used by the trip type clustering machine learning model are not affected by an incorrect orientation of the tracking device in the vehicle because the data used by the trip type clustering machine learning model are generated by the tracking device signal receiving component and not the tracking device, itself.

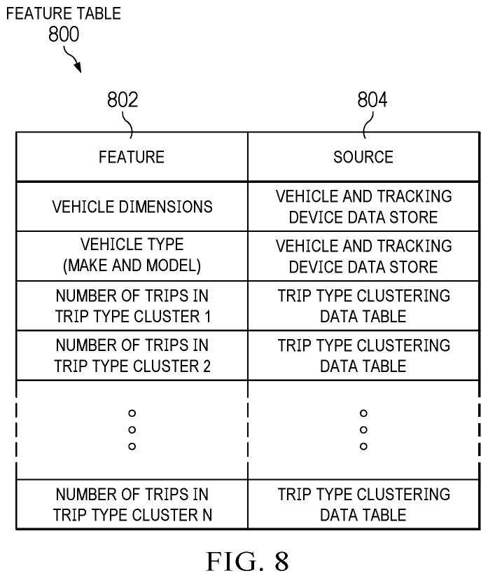

With reference now to FIG. 8, a diagram illustrating an example of a feature table is depicted in accordance with an illustrative embodiment. Feature table 800 can be implemented by, for example, a tracking device signal regression machine learning model such as tracking device signal regression machine learning model 218 in FIG. 2.

In this example, feature table 800 includes 2 columns: feature 802 and source 804. Feature 802 identifies a name of the information used by the tracking device signal regression machine learning model. Source 804 identifies the table where the information used by the tracking device signal regression machine learning model can be located.

At the end of each completed trip, the tracking device signal regression machine learning model predicts the expected number of tracking device data signals that should be received given the set of features in feature table 800. An anomaly detection component, such as, for example, anomaly detection component 222 in FIG. 2, compares the predicted number of data signals with the actual number of data signals received. In response to the anomaly detection component determining that the difference between the predicted number of data signals and the actual number of data signals received is greater than a predefined maximum difference threshold level (e.g., known error of the tracking device signal regression machine learning model), the anomaly detection component determines that that particular trip is an anomalous trip for the tracking device.

After detecting a set of anomalies for that tracking device, the anomaly detection component sends a notification to an operational dashboard interface on a client device regarding the tracking device anomaly. In addition, the anomaly detection component can automatically initiate a diagnostic test of that tracking device to determine whether a software issue or a hardware issue exists causing the anomaly. In response to the anomaly detection component determining that a software issue exists based on the diagnostic test, then the computer, such as, for example, computer 101 in FIG. 1 or server computer 202 in FIG. 2, can search for and download a software fix (e.g., patch, update, or the like) to the tracking device to correct the software issue. If the anomaly detection component determines that a hardware issue exists based on the diagnostic test, then the computer can generate a ticket to have the hardware issue fixed in the tracking device. If the anomaly is caused by misorientation of the IoT tracking device and not a software or hardware issue, then the computer can generate a ticket to have the tracking device correctly oriented in the vehicle. Alternatively, the anomaly detection component can automatically recalibrate the tracking device so that previous anomalous vehicle movement data signals received from the tracking device are now considered by the signal receiving component as movement of the vehicle in a normal direction.

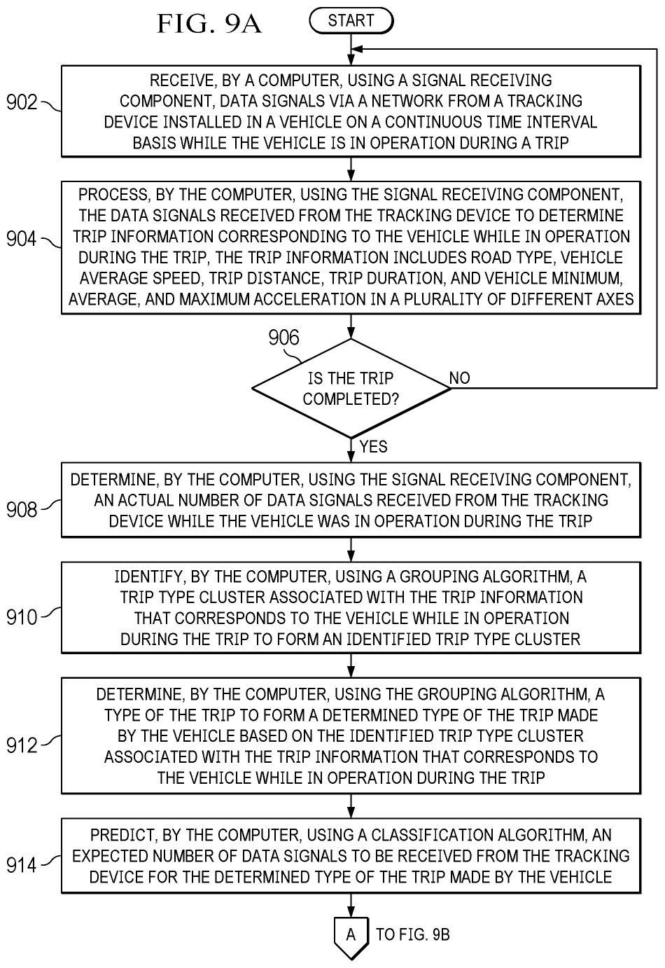

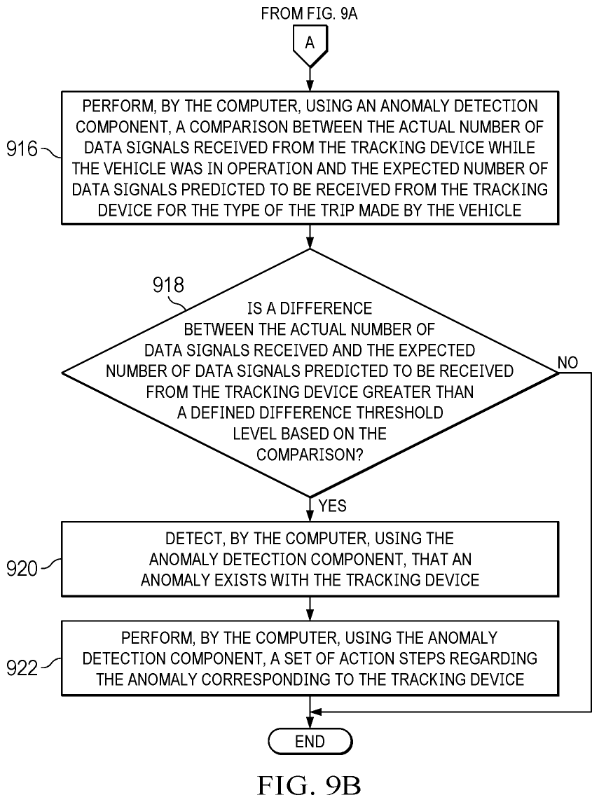

With reference now to FIGS. 9A-9B, a flowchart illustrating a process for detecting vehicle tracking device anomaly is shown in accordance with an illustrative embodiment. The process shown in FIGS. 9A-9B may be implemented in a computer, such as, for example, computer 101 in FIG. 1 or server computer 202 in FIG. 2. For example, the process shown in FIGS. 9A-9B may be implemented in tracking device anomaly detection code 200 in FIG. 1.

The process begins when the computer, using a signal receiving component, receives data signals via a network from a tracking device installed in a vehicle on a continuous time interval basis while the vehicle is in operation during a trip (step 902). The tracking device is an IoT tracking device comprised of a system of IoT sensors. The computer, using the signal receiving component, processes the data signals received from the tracking device to determine trip information corresponding to the vehicle while in operation during the trip (step 904). The trip information includes road type, vehicle average speed, trip distance, trip duration, and vehicle minimum, average, and maximum acceleration in a plurality of different axes.

The computer, using the signal receiving component, makes a determination as to whether the trip is completed (step 906). The computer, using the signal receiving component, determines that the trip is completed by receiving an end signal from the tracking device when the vehicle is turned off. Alternatively, the computer, using the signal receiving component, determines that the trip is completed by not receiving a signal from the tracking device for a defined interval of time.

If the computer, using the signal receiving component, determines that the trip is not completed, no output of step 906, then the process returns to step 902 where the computer, using the signal receiving component, continues to receive data signals from the tracking device. If the computer, using the signal receiving component, determines that the trip is completed, yes output of step 906, then the computer, using the signal receiving component, determines an actual number of data signals received from the tracking device while the vehicle was in operation during the trip (step 908).

Further, the computer, using a grouping algorithm, identifies a trip type cluster associated with the trip information that corresponds to the vehicle while in operation during the trip to form an identified trip type cluster (step 910). The grouping algorithm is a trip type clustering machine learning model that was trained using historical trip type information. Furthermore, the computer, using the grouping algorithm, determines a type of the trip to form a determined type of the trip made by the vehicle based on the identified trip type cluster associated with the trip information that corresponds to the vehicle while in operation during the trip (step 912).

Moreover, the computer, using a classification algorithm, predicts an expected number of data signals to be received from the tracking device for the determined type of the trip made by the vehicle (step 914). The classification algorithm is a tracking device signal regression machine learning model that was trained on historical actual numbers of received data signals for a plurality of different types of trips.

Afterward, the computer, using an anomaly detection component, performs a comparison between the actual number of data signals received from the tracking device while the vehicle was in operation and the expected number of data signals predicted to be received from the tracking device for the type of the trip made by the vehicle (step 916). The computer, using the anomaly detection component, makes a determination as to whether a difference between the actual number of data signals received and the expected number of data signals predicted to be received from the tracking device is greater than a defined difference threshold level based on the comparison (step 918).

If the computer, using the anomaly detection component, determines that the difference between the actual number of data signals received and the expected number of data signals predicted to be received from the tracking device is not greater than the defined difference threshold level based on the comparison, no output of step 918, then the process terminates thereafter. If the computer, using the anomaly detection component, determines that the difference between the actual number of data signals received and the expected number of data signals predicted to be received from the tracking device is greater than the defined difference threshold level based on the comparison, yes output of step 918, then the computer, using the anomaly detection component, detects that an anomaly exists with the tracking device (step 920).

In response to the computer, using the anomaly detection component, detecting that an anomaly does exist with the tracking device, the computer, using the anomaly detection component, performs a set of action steps regarding the anomaly corresponding to the tracking device (step 922). The set of action steps includes at least one of sending a notification regarding the anomaly to a user via an operational dashboard interface on a client device, initiating a diagnostic test of the tracking device to determine whether a software issue or a hardware issue exists causing the anomaly, downloading a software fix to the tracking device to correct the software issue in response to determining that a software issue does exist based on the diagnostic test, generating a ticket to have the hardware issue fixed in response to determining that a hardware issue does exist based on the diagnostic test, generating a ticket to have the tracking device correctly oriented in the vehicle in response to determining that a software issue or a hardware issue does not exist based on the diagnostic test, or recalibrate the tracking device so that previous anomalous vehicle movement data signals received from the tracking device are now considered by the signal receiving component as movement of the vehicle in a normal direction. Thereafter, the process terminates.

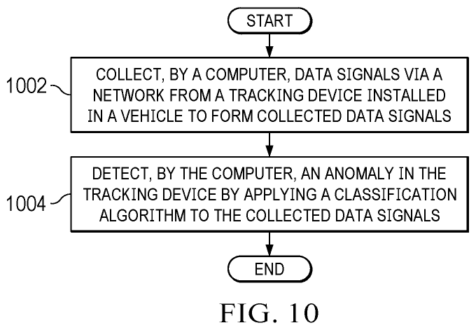

With reference now to FIG. 10, a flowchart illustrating a process for anomaly detection is shown in accordance with an illustrative embodiment. The process shown in FIG. 10 may be implemented in a computer, such as, for example, computer 101 in FIG. 1 or server computer 202 in FIG. 2. For example, the process shown in FIG. 10 may be implemented in tracking device anomaly detection code 200 in FIG. 1.

The process begins when the computer collects data signals via a network from a tracking device installed in a vehicle to form collected data signals (step 1002). The computer detects an anomaly in the tracking device by applying a classification algorithm to the collected data signals (step 1004). Thereafter, the process terminates.

Thus, illustrative embodiments of the present invention provide a computer-implemented method, computer system, and computer program product for detecting vehicle tracking device anomalies based on data signals generated by the tracking devices, themselves, using grouping and classification algorithms. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for detecting vehicle tracking device anomaly, the computer-implemented method comprising:
collecting, by a computer, data signals via a network from a tracking device installed in a vehicle to form collected data signals; and
detecting, by the computer, an anomaly in the tracking device by applying a classification algorithm to the collected data signals.

2. The computer-implemented method of claim 1, further comprising:
performing, by the computer, a comparison between an actual number of data signals received from the tracking device while the vehicle was in operation and an expected number of data signals predicted to be received from the tracking device for a type of a trip made by the vehicle;
determining, by the computer, whether a difference between the actual number of data signals received and the expected number of data signals predicted to be received from the tracking device is greater than a defined difference threshold level based on the comparison; and
detecting, by the computer, that the anomaly exists with the tracking device in response to the computer determining that the difference between the actual number of data signals received and the expected number of data signals predicted to be received from the tracking device is greater than the defined difference threshold level.

3. The computer-implemented method of claim 2, further comprising:
performing, by the computer, a set of action steps regarding the anomaly corresponding to the tracking device in response to the computer detecting that the anomaly exists with the tracking device.

4. The computer-implemented method of claim 3, wherein the set of action steps includes at least one of sending a notification regarding the anomaly to a user via an operational dashboard interface on a client device, initiating a diagnostic test of the tracking device to determine whether a software issue or a hardware issue exists causing the anomaly, downloading a software fix to the tracking device to correct the software issue in response to determining that the software issue does exist based on the diagnostic test, generating a ticket to have the hardware issue fixed in response to determining that the hardware issue does exist based on the diagnostic test, generating a ticket to have the tracking device correctly oriented in the vehicle in response to determining that the software issue or the hardware issue does not exist based on the diagnostic test, or recalibrate the tracking device so that previous anomalous vehicle movement data signals received from the tracking device are now considered as movement of the vehicle in a normal direction.

5. The computer-implemented method of claim 2, further comprising:
receiving, by the computer, the data signals via the network from the tracking device installed in the vehicle on a continuous time interval basis while the vehicle is in operation during the trip; and
processing, by the computer, the data signals received from the tracking device to determine trip information corresponding to the vehicle while in operation during the trip, wherein the trip information includes road type, vehicle average speed, trip distance, trip duration, and vehicle minimum, average, and maximum acceleration in a plurality of different axes.

6. The computer-implemented method of claim 5, further comprising:
determining, by the computer, whether the trip is completed;
determining, by the computer, the actual number of data signals received from the tracking device while the vehicle was in operation during the trip;
identifying, by the computer, using a grouping algorithm, a trip type cluster associated with the trip information that corresponds to the vehicle while in operation during the trip to form an identified trip type cluster; and
determining, by the computer, using the grouping algorithm, the type of the trip to form a determined type of the trip made by the vehicle based on the identified trip type cluster associated with the trip information that corresponds to the vehicle while in operation during the trip.

7. The computer-implemented method of claim 6, wherein the grouping algorithm is a trip type clustering machine learning model that was trained using historical trip type information.

8. The computer-implemented method of claim 7, further comprising:
predicting, by the computer, using the classification algorithm, the expected number of data signals to be received from the tracking device for the determined type of the trip made by the vehicle.

9. The computer-implemented method of claim 8, wherein the classification algorithm is a tracking device signal regression machine learning model that was trained on historical actual numbers of received data signals for a plurality of different types of trips.

10. A computer system for detecting vehicle tracking device anomaly, the computer system comprising:
a communication fabric;
a storage device connected to the communication fabric, wherein the storage device stores program instructions; and
a processor connected to the communication fabric, wherein the processor executes the program instructions to:
collect data signals via a network from a tracking device installed in a vehicle to form collected data signals; and
detect an anomaly in the tracking device by applying a classification algorithm to the collected data signals.

11. The computer system of claim 10, wherein the processor further executes the program instructions to:
perform a comparison between an actual number of data signals received from the tracking device while the vehicle was in operation and an expected number of data signals predicted to be received from the tracking device for a type of a trip made by the vehicle;
determine whether a difference between the actual number of data signals received and the expected number of data signals predicted to be received from the tracking device is greater than a defined difference threshold level based on the comparison; and
detect that the anomaly exists with the tracking device in response to determining that the difference between the actual number of data signals received and the expected number of data signals predicted to be received from the tracking device is greater than the defined difference threshold level.

12. The computer system of claim 11, wherein the processor further executes the program instructions to:
perform a set of action steps regarding the anomaly corresponding to the tracking device in response to detecting that the anomaly exists with the tracking device.

13. A computer program product for detecting vehicle tracking device anomaly, the computer program product comprising a computer-readable storage medium having program instructions embodied therewith, the program instructions executable by a computer to cause the computer to perform a method of:
collecting, by a computer, data signals via a network from a tracking device installed in a vehicle to form collected data signals; and
detecting, by the computer, an anomaly in the tracking device by applying a classification algorithm to the collected data signals.

14. The computer program product of claim 13, further comprising:
performing, by the computer, a comparison between an actual number of data signals received from the tracking device while the vehicle was in operation and an expected number of data signals predicted to be received from the tracking device for a type of a trip made by the vehicle;
determining, by the computer, whether a difference between the actual number of data signals received and the expected number of data signals predicted to be received from the tracking device is greater than a defined difference threshold level based on the comparison; and
detecting, by the computer, that an anomaly exists with the tracking device in response to the computer determining that the difference between the actual number of data signals received and the expected number of data signals predicted to be received from the tracking device is greater than the defined difference threshold level.

15. The computer program product of claim 14, further comprising:
performing, by the computer, a set of action steps regarding the anomaly corresponding to the tracking device in response to the computer detecting that the anomaly exists with the tracking device.

16. The computer program product of claim 15, wherein the set of action steps includes at least one of sending a notification regarding the anomaly to a user via an operational dashboard interface on a client device, initiating a diagnostic test of the tracking device to determine whether a software issue or a hardware issue exists causing the anomaly, downloading a software fix to the tracking device to correct the software issue in response to determining that the software issue does exist based on the diagnostic test, generating a ticket to have the hardware issue fixed in response to determining that the hardware issue does exist based on the diagnostic test, generating a ticket to have the tracking device correctly oriented in the vehicle in response to determining that the software issue or the hardware issue does not exist based on the diagnostic test, or recalibrate the tracking device so that previous anomalous vehicle movement data signals received from the tracking device are now considered as movement of the vehicle in a normal direction.

17. The computer program product of claim 14, further comprising:
receiving, by the computer, the data signals via the network from the tracking device installed in the vehicle on a continuous time interval basis while the vehicle is in operation during the trip; and
processing, by the computer, the data signals received from the tracking device to determine trip information corresponding to the vehicle while in operation during the trip, wherein the trip information includes road type, vehicle average speed, trip distance, trip duration, and vehicle minimum, average, and maximum acceleration in a plurality of different axes.

18. The computer program product of claim 17, further comprising:
determining, by the computer, whether the trip is completed; and
determining, by the computer, the actual number of data signals received from the tracking device while the vehicle was in operation during the trip.

19. The computer program product of claim 17, further comprising:
identifying, by the computer, using a grouping algorithm, a trip type cluster associated with the trip information that corresponds to the vehicle while in operation during the trip to form an identified trip type cluster; and
determining, by the computer, using the grouping algorithm, the type of the trip to form a determined type of the trip made by the vehicle based on the identified trip type cluster associated with the trip information that corresponds to the vehicle while in operation during the trip.

20. The computer program product of claim 19, further comprising:
predicting, by the computer, using the classification algorithm, the expected number of data signals to be received from the tracking device for the determined type of the trip made by the vehicle.
